(19) United States
(12) Patent Application Publication
(10) Pub. No.: US 2008/0068252 A1
(43) Pub. Date: Mar. 20, 2008

(54) Simulcasting content information on WiFi

(76) Inventors: Pratik M. Mehta, Austin, TX (US); Neeraj Srivastava, Austin, TX (US)

Correspondence Address: HAMILTON & TERRILE, LLP, P.O. BOX 203518, AUSTIN, TX, 78720, US

(21) Appl. No.: 11/533,052

(22) Filed: Sep. 19, 2006

(51) Int. Cl. G01S 13/58

(52) U.S. Cl. 342/115

(57) ABSTRACT

A system and method is disclosed for decoupling and simulcasting metadata from digitized audio and/or video content to facilitate an on-line purchase of a copy of the content. One or more digitized audio/video content streams containing metadata are intercepted prior to being played. Metadata associated with the audio/video content within the intercepted stream is identified, decoupled, and wirelessly simulcasted by a metadata simulcaster such that it can be automatically received, stored and enacted upon by similarly enabled wireless devices to facilitate on-line purchases of the associated content, in electronic or physical form, at the present or a later time. Audio content metadata received via satellite radio is similarly intercepted by a mobile metadata simulcaster and locally simulcast via a wireless protocol such as, but not limited to, Bluetooth to similarly enabled wireless devices to facilitate on-line purchases of audio content through a wireless wide area network connection to the Internet.

### BACKGROUND OF THE INVENTION

1. Field of the Invention

The present invention relates in general to the field of digitized content delivery and more specifically, to providing simulcast metadata that facilitates its purchase.

2. Description of the Related Art

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

The delivery of digitized audio/video (A/V) content to a variety of information handling systems has become commonplace. In the past, collateral information about A/V content, including the publisher, artist, track length, lyrics, and so forth, was generally provided in the form of printed inserts (e.g., liner notes) or on the content's physical packaging itself. With the growing acceptance of digital delivery, the concept of incorporating metadata (i.e., data about the data) with digitized content is now standard practice. For example, compact disks (CDs) include a unique identification code that can be referenced to retrieve metadata from databases (e.g., compact disk database, or CDDB) that are accessible through the Internet. Currently, other forms of digital delivery including digital versatile disk (DVD), mini-disk (MD), and motion picture expert group layer 3 (MP3) inherently include metadata. Likewise, digital delivery systems including digital cable, direct broadcast satellite (DBS), satellite radio, digital broadcast radio, and Internet streaming media and multi-casting similarly include metadata about audio and video content, commonly referred to program-associated data (PAD).

A popular metadata format for digitized content is ID3, a file tagging system originally developed for including information such as artist, album name, song title, and track length with MP3-encoded audio files. The first version of ID3 appended a 128 byte block of data at the end of the MP3 file, which presented problems with some early MP3 players and also prevented ID3 information from being displayed as it was being played. The current version of ID3, version 2 and its variants, defines an extensible data structure limited to a total size of 256 MB, prepended as a block of code to the front of a digitized content file. The ID3v2 code block is comprised of frames, each of which can be up to 16 MB in size and can contain multiple types of A/V metadata, including but not limited to, lyrics, images, copyright information, and even Internet addresses where the A/V content can be obtained.

Currently, ID3 tags and other forms of digitized content metadata are viewed on the display screen of a content delivery system such as, but not limited to, a personal computer, a DVD disk player, a portable media player, a satellite radio receiver, or a video screen attached to a satellite or cable receiver. While these devices are generally used in the home, in an automobile, or carried by an individual, it is becoming increasingly common for venues such as restaurants, coffee shops, exhibition halls, and other public places to have large video screens and/or sound systems for the delivery of A/V content. The playing of music and/or video in these and other venues not only helps create an atmosphere or ambiance, but it often generates an impulsive desire for patrons to acquire their own copy of the content being played. In the past, the viewer or listener was frustrated because they often didn't know the title or artist name. Today, however, it is not uncommon for some metadata to be displayed on a video screen as A/V content is played in these venues, even to the extent of providing the Internet address where the content can be purchased. Many of these same venues provide access to the Internet, often at no charge, for the convenience of their customers or attendees. Display of A/V content metadata, combined with access to the Internet, provides the means for a listener or viewer to enter the appropriate metadata into an Internet-enabled device and purchase the associated content, which can either be downloaded in digitized form while the customer is still present in the venue, downloaded at a later time or on a different device, or delivered in physical form to a physical address.

However, entering metadata displayed on a video screen into an Internet-enabled device can present challenges. For example, the metadata may no longer be displayed by the time the listener can access and boot their laptop computer or PDA, or they may not have sufficient time to enter the required metadata into their browser, or it may be misskeyed when entered. Furthermore, the impulse to purchase can quickly vanish if the purchase initiation process is too complicated, cumbersome, or takes too long. Similarly, if the purchase is delayed to a later time, the purchaser may forget to act on their initial impulse. In other cases, the content delivery system in a venue may be audio-only, with no means of displaying A/V content metadata, resulting in a prospective buyer not having the information necessary to purchase the associated content. Some Internet media streaming services such as Rhapsody make it possible to tag a song for purchase, but they require using the same device and media used to deliver the A/V content. While this approach may be convenient for users sitting in front of a computer, it is not always practical for would-be content purchasers in a public venue. In view of the foregoing, there is a need for automatically providing digitized A/V content metadata to Internet-enabled devices to facilitate the purchase of its associated content.

### SUMMARY OF THE INVENTION

Various embodiments of the present invention comprise a system and method for decoupling metadata from digitized content and wirelessly simulcasting the metadata whereby it can be automatically received, stored and used by wireless devices. In some embodiments of the invention, one or more digitized audio/video (A/V) content streams containing metadata are intercepted prior to being played in a venue. Metadata associated with the A/V content within the intercepted stream is identified, decoupled, and wirelessly simulcast by a metadata simulcaster. In an embodiment of the invention, the metadata may comprise metadata contained within an ID3v2 tag.

In various embodiments, wireless devices receive the simulcast A/V metadata, including on-line purchase information, such as the content provider's Internet address, to facilitate purchasing a copy of the associated content. In one embodiment of the invention, A/V content metadata is “pushed” to the wireless device, where it is displayed as it is simulcasted by the metadata simulcaster. In another embodiment of the invention, the metadata simulcaster acts as a server to “pull” the wireless device user to simulcasted and/or stored A/V content metadata. In yet another embodiment of the invention, the wireless user can access historical metadata of A/V content that was previously played. In some embodiments, the wireless device user can select A/V metadata for a single selection, an entire playlist, or a partial play list, and save the metadata to the wireless device to use as reference for later use when purchasing the associated content.

In some embodiments of the invention, the A/V content can be purchased, paid for, and downloaded from an on-line content provider's site to the buyer's wireless device through the venue's wireless access point. In another embodiment of the invention, the wireless device user can download the selected A/V content from a content delivery site. In yet another embodiment of the invention, the wireless device user can elect to purchase a physical copy of the audio video/content from an on-line merchant and have it delivered to a physical address.

In various embodiments of the invention, digitized audio content containing metadata is received via a satellite radio, with the metadata being intercepted by a mobile metadata simulcaster and locally simulcasted via a wireless protocol such as Bluetooth. The simulcasted metadata is received by wireless devices which use the metadata to facilitate an on-line purchase of the audio content, in electronic or physical form, either at the present or a future time. In an embodiment of the invention, metadata from a satellite radio is simulcast to wireless devices in a stationary venue such as a home, office, or public place, and the associated audio content is purchased on-line through wireless or physical access to the Internet. In other embodiments of the invention, the satellite radio is implemented in a mobile environment, and the associated audio content is purchased on-line through a wireless wide area network (WWAN) connection to the Internet. Those of skill in the art will understand that many such embodiments and variations of the invention are possible, including but not limited to those described hereinabove, which are by no means all inclusive.

### BRIEF DESCRIPTION OF THE DRAWINGS

The present invention may be better understood, and its numerous objects, features and advantages made apparent to those skilled in the art by referencing the accompanying drawings. The use of the same reference number throughout the several figures designates a like or similar element.

FIG. 1 is a generalized illustration of an information handling system that can be used to implement the system and method of the present invention;

FIG. 2 is a generalized illustration of a prior art ID3v2 tag as commonly implemented to provide metadata for digitized audio/video content;

FIG. 3 is a generalized flowchart of a metadata simulcast system as implemented in accordance with an embodiment of the invention for the simulcasting of audio/video metadata to facilitate an on-line purchase of a copy of associated content;

FIG. 4 is a generalized block diagram illustrating an implementation of a metadata simulcaster as used in accordance with an embodiment of the invention for the simulcasting of audio/video metadata to a wireless device to facilitate an on-line purchase of an electronic copy of the associated content;

FIG. 5 is a generalized block diagram illustrating an implementation of a metadata simulc aster as used in accordance with an embodiment of the invention for the simulcasting of audio/video metadata to a wireless device to facilitate an on-line purchase of a physical copy of the associated content;

FIG. 6 is a generalized block diagram illustrating an implementation of a metadata simulcaster as used in accordance with an embodiment of the invention for the simulcasting of audio/video metadata to a wireless device to facilitate an on-line purchase of an electronic and /or physical copy of the associated content, and;

FIG. 7 is a generalized block diagram illustrating an implementation of a mobile metadata simulc aster as used in accordance with an embodiment of the invention for the simulcasting of audio metadata to a wireless device to facilitate an on-line purchase of a electronic or physical copy of the associated content in a mobile environment.

### DETAILED DESCRIPTION

A system and method is disclosed for decoupling metadata from digitized content before it is played and wirelessly simulcasting the metadata such that it can be automatically received, stored and enacted upon by similarly enabled wireless devices. In various embodiments of the invention, wireless receipt of simulcasted metadata facilitates an on-line purchase of a copy of the associated content, in electronic or physical form, at the present or a later time.

For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, and a video display. The information handling system may also include one or more buses operable to transmit communications between the various hardware components.

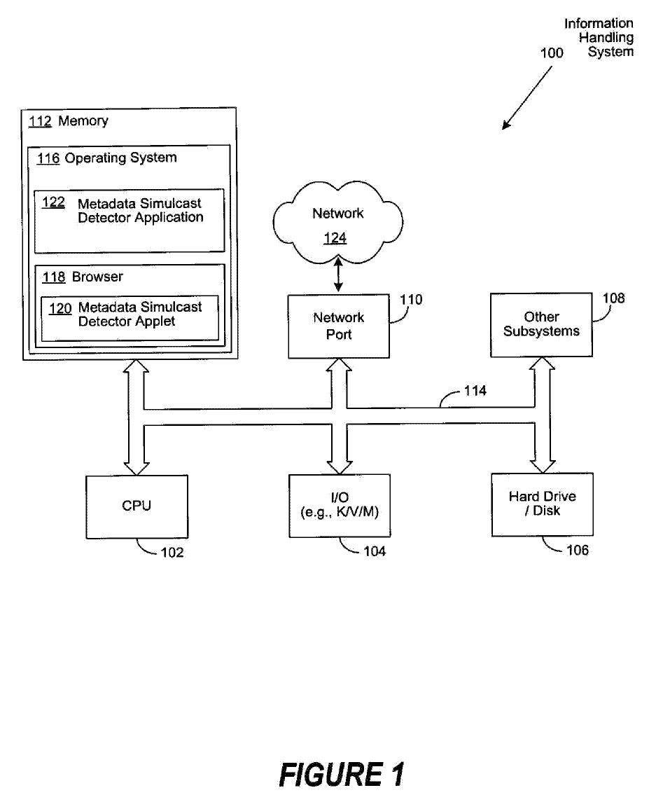

FIG. 1 is a generalized illustration of an information handling system 100 that can be used to implement the system and method of the present invention. The information handling system includes a processor (e.g., central processor unit or “CPU”) 102, input/output (I/O) devices 104, such as a display, a keyboard, a mouse, and associated controllers, a hard drive or disk storage 106, various other subsystems 108, network port 110 operable to connect to a network 124, and system memory 112, all interconnected via one or more buses 114. Operating system 116 resides in system memory 112 and in an embodiment of the invention supports an implementation of a Web browser 118 which can be utilized by the present invention for implementation of metadata simulcast detector applet 120. Operating system 116 further supports implementation of metadata simulcast detector application 122, which does not require the implementation of a browser.

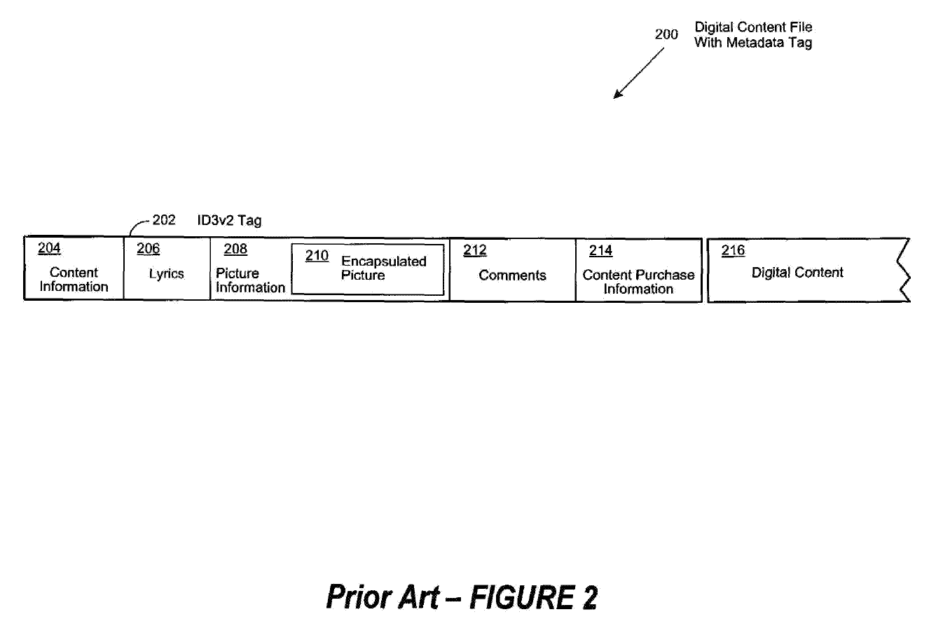

FIG. 2 is a generalized illustration of a prior art ID3v2 tag 202 as commonly implemented to provide metadata for digitized audio/video (A/V) content 216. In this illustration, a digital content file with associated metadata 200 comprises ID3v2 tag 202 prepended to digitized A/V content 216. ID3v2 tag 202 comprises, but is not limited to, content data 204, lyrics 206, picture information 208, which further comprises encapsulated picture 210, comments 212, and content purchase information 214. Content data 204 comprises, but is not limited to, song title, artist name, album name, year produced, track number, track length, and genre. Content purchase information 214 comprises information facilitating the on-line purchase of the associated A/V content including, but not limited to, the Internet address of on-line content providers, pricing, special promotions, availability dates, and copyright information. For example, those of skill in the art familiar with ID3v2 metadata tags will recognize that its extensible data structure, which is comprised of frames, allows the flexible accommodation of these types of metadata, which can be simulcast in accordance with different embodiments of the invention.

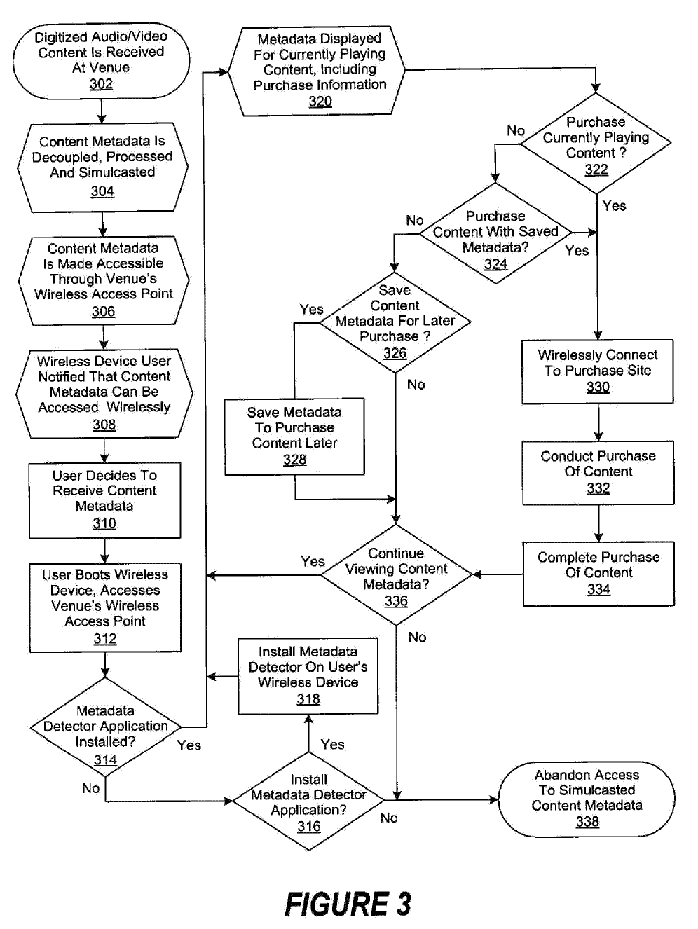

FIG. 3 is a generalized flowchart of a metadata simulcast system as implemented in accordance with an embodiment of the invention for the simulcasting of audio/video (A/V) metadata to facilitate an on-line purchase of a copy of associated content. In step 302, a digitized A/V content stream is received at a venue which can include, but is not limited to, an office, a public place, a private home, or a mobile vehicle. In step 304, a metadata simulcaster, as implemented in accordance with an embodiment of the invention, decouples metadata from the incoming A/V content stream, stores it internally on the metadata simulcaster or on an external host for remote and/or later retrieval, and simulcasts it as it is being played by a digital content player. In different embodiments of the invention, decoupled metadata is time stamped and supplemental metadata is appended or substituted including, but not limited to, unique identifiers of the venue where the content is being played, Internet addresses of on-line providers of the A/V content, and special promotions prior to it being stored and simulcast.

In step 306, decoupled and processed metadata is wirelessly simulcast by the metadata simulcaster using one or more protocols such as, but not limited to, 802.11 (WiFi), short message service (SMS), Bluetooth, or general packet radio service (GPRS). In step 308, wireless device users are notified that metadata associated with the A/V content being played is available for access by wireless-enabled devices including, but not limited to, laptop computers, personal digital assistants (PDAs), portable media players and cell phones. In one embodiment of the invention, notification is displayed on a video screen along with the metadata while the content is being played. In another embodiment of the invention, such as in an audio-only environment, wireless device users are notified when they access the venue's wireless access point for access to the Internet. In another embodiment of the invention in an audio-only environment, wireless device users are notified of the availability of A/V content metadata verbally or through printed materials.

In step 310, the wireless device user decides to receive simulcasted A/V content metadata, and in step 312 boots their wireless device to connect to the venue's wireless access point. If it is determined in step 314 that a metadata detector application or applet is currently implemented on the user's wireless device, then links to the A/V content metadata or the metadata itself is displayed on the wireless device in step 320 The displayed or linked metadata can include information facilitating an on-line purchase of the associated A/V content as described in greater detail hereinabove.

Otherwise, the wireless device user is prompted in step 316 to install a metadata detector application or applet. In one embodiment of the invention, the A/V metadata detector application or applet automatically detects and displays A/V content metadata that is simulcasted, or “pushed”, by the metadata simulcaster. In another embodiment of the invention, the metadata detector application or applet displays an advisory screen or link to “pull” the wireless device user to the metadata simulcaster, which acts as a server for providing simulcasted and/or stored A/V content metadata. If the wireless device user decides to not install a metadata detector application or applet in step 316, then access to simulcasted A/V content metadata is abandoned in step 338. If the wireless device user decides to install a metadata detector application or applet in step 316, then it is installed on the user's wireless device in step 318. Once the metadata detector application or applet is installed, links to the A/V content metadata or the metadata itself, including information facilitating an on-line purchase of the associated A/V content, is displayed on the wireless device in step 320 as described in greater detail hereinabove. The wireless device user is then prompted in step 322 to purchase the associated A/V content. If the wireless device user decides to not purchase the associated A/V content in step 322, then they are prompted in step 324 to purchase other A/V content with previously saved metadata. If the wireless device user decides to not purchase other A/V content in step 324, they are prompted in step 326 to save the A/V content metadata for facilitating a later purchase of the associated A/V content.

If the wireless device user decides in step 326 to save the A/V content metadata, then the metadata is stored on their wireless device in step 328. If the wireless device user decides in step 326 to not save the A/V content metadata, then they are prompted in step 336 to continue viewing A/V content metadata. If the wireless device user decides in step 336 to continue viewing A/V content metadata, then the wireless device user is returned to step 320 and the process continues. If the wireless device user decides in step 336 to not continue viewing A/V content metadata, then access to simulcasted A/V content metadata is abandoned in step 338. If the wireless device user decides to purchase the associated A/V content in step 322, they are then wirelessly connected to an on-line content provider in step 330, where they conduct a purchase of the associated A/V content in step 332, and complete the purchase in step 334. After completing the purchase of the associated A/V content in step 334, the wireless device user is returned to step 336, where they are prompted to continue viewing A/V content metadata. If the wireless device user decides in step 336 to continue viewing A/V content metadata, then the wireless device user is returned to step 320 and the process continues. If the wireless device user decides in step 336 to not continue viewing A/V content metadata, then access to simulcasted A/V content metadata is abandoned in step 338.

If the wireless device user decides to not purchase the associated A/V content in step 322, but decides to purchase other A/V content in step 324 with previously saved A/V content metadata, then they are then wirelessly connected to an on-line content provider in step 330. Once connected, they conduct a purchase of the associated A/V content in step 332, and complete the purchase in step 334. After completing the purchase of the associated A/V content in step 334, the wireless device user is returned to step 336, where they are prompted to continue viewing A/V content metadata. If the wireless device user decides in step 336 to continue viewing A/V content metadata, then the wireless device user is returned to step 320 and the process continues. If the wireless device user decides in step 336 to not continue viewing A/V content metadata, then access to simulcasted A/V content metadata is abandoned in step 338.

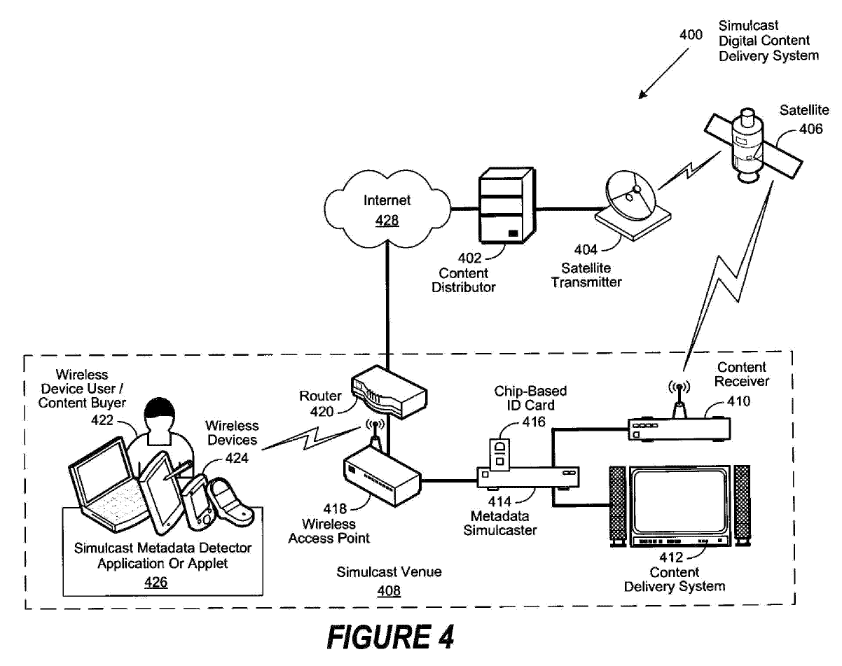

FIG. 4 is a generalized block diagram illustrating an implementation of a metadata simulcaster 414 as used in accordance with an embodiment of the invention for the simulcasting of audio/video (A/V) metadata to a wireless device to facilitate an on-line purchase of an electronic copy of the associated content. In this embodiment of the invention, simulcast digital content delivery system 400 comprises content distributor 402, coupled to the Internet 428 and satellite transmitter 404, satellite 406, and simulcast venue 408. Content distributor 402 streams predetermined A/V content with associated metadata to satellite transmitter 404, which transmits it to satellite 406 for broadcast to simulcast venue 408.

Simulcast venue 408 comprises content receiver 410, A/V content delivery system 412, A/V metadata simulcaster 414, wireless access point 418, router 420, wireless device user/content buyer 422 and wireless devices 424 implemented with metadata simulcast detector application or applet 426. In an embodiment of the invention, digitized A/V content broadcast from satellite 406 is received by content receiver 410, where it is intercepted by metadata simulcaster 414, which decouples and simulcasts metadata associated with the A/V content as it is being played by content delivery system 412. In different embodiments of the invention, decoupled metadata is time stamped and supplemental metadata is appended or substituted including, but not limited to, unique identifiers of the venue where the content is being played, Internet addresses of on-line providers of the A/V content, and special promotions. In an embodiment of the invention, metadata simulcaster 414 comprises a chip-based identification card 416, which provides metadata origination information to facilitate an on-line purchase of associated A/V content. After A/V content metadata is decoupled from the intercepted digitized A/V content stream and processed, it is then stored internally in metadata simulcaster 414 or on an external host for remote and/or later retrieval. Metadata simulcaster 414 then wirelessly simulcasts the processed metadata through wireless access port 418 using one or more protocols such as, but not limited to, 802.11 (WiFi), short message service (SMS), or general packet radio service (GPRS).

Wireless device users who are potential A/V content buyers 422 are notified that metadata associated with the A/V content currently being played is available through the use of wireless-enabled devices 424 including, but not limited to laptop computers, personal digital assistants (PDAs), portable media players and cell phones. In one embodiment of the invention, notification is displayed on a video screen of content delivery system 412 along with the metadata. In another embodiment of the invention, such as when content delivery system 412 only provides audio, wireless device users/content buyers 422 are notified when they access the venue's wireless access point 418 for access to the Internet 428. In another embodiment of the invention in an audio-only environment, wireless device users/content buyers 422 are notified of the availability of A/V content metadata verbally or through printed materials.

Wireless device users/content buyers 422 who decide to receive simulcasted A/V content metadata boot their wireless devices 424 to connect to the venue's wireless access point 418 at which point the wireless device user/content buyer 422 is prompted to install metadata detector application or applet 426. In one embodiment of the invention, the A/V metadata detector application or applet automatically detects and displays A/V content metadata that is simulcasted, or “pushed”, by the metadata simulcaster. In another embodiment of the invention, the metadata detector application or applet displays an advisory screen or link to “pull” the wireless device user to the metadata simulcaster, which acts as a server for providing simulcasted and/or stored A/V content metadata. Once a metadata detector application or applet 426 is installed on a wireless device 424, A/V content metadata, including information facilitating an on-line purchase of the associated A/V content, is displayed on the wireless device 424 as described in greater detail hereinabove. In an embodiment of the invention, A/V content metadata displayed on wireless devices 424 includes time-stamped and supplemental metadata including, but not limited to, unique identifiers of the venue 408 where the content is being played, Internet addresses of on-line providers of the A/V content, and special promotions.

In this embodiment of the invention, the wireless device user/content buyer 422 can use the displayed A/V content metadata to facilitate the enactment of an on-line purchase of the associated A/V content. When the wireless device user/content buyer 422 decides to purchase the associated A/V content, they are wirelessly connected to content distributor 402 through wireless access point 418, which is connected to router 420, which in turn is coupled to the Internet 428. Once connected to content distributor 402, the wireless device user/content buyer 422 conducts and completes a purchase of the associated A/V content. Once the purchase is completed, the associated A/V content is downloaded through Internet 428, through router 420 and wireless access point 418, and on to wireless devices 424. In another embodiment of the invention, if the wireless device user 422 decides not to purchase the associated A/V content at that time, the A/V content metadata is saved to the wireless device 424 facilitating a later purchase of the associated A/V content.

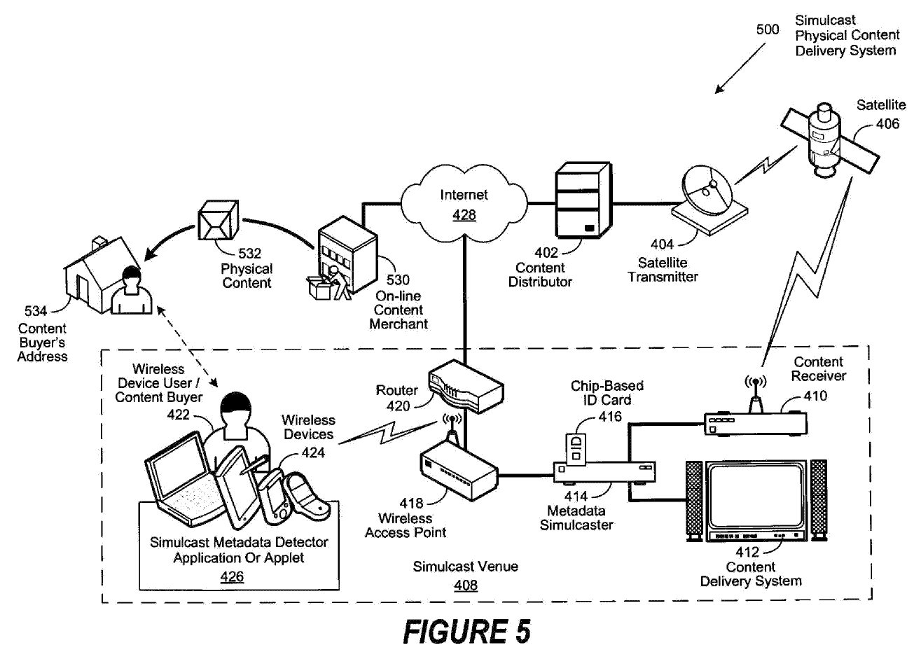

FIG. 5 is a generalized block diagram illustrating an implementation of a metadata simulcaster 414 as used in accordance with an embodiment of the invention for the simulcasting of audio/video (A/V) metadata to a wireless device to facilitate an on-line purchase of a physical copy of the associated content. In this embodiment of the invention, simulcast physical content delivery system 500 comprises content distributor 402, coupled to the Internet 428 and satellite transmitter 404, satellite 406, simulcast venue 408, on-line content merchant 530, physical content 532, and content buyer's address 534. Content distributor 402 streams predetermined A/V content with associated metadata to satellite transmitter 404, which transmits it to satellite 406 for broadcast to simulcast venue 408.

Simulcast venue 408 comprises content receiver 410, A/V content delivery system 412, A/V metadata simulcaster 414, wireless access point 418, router 420, wireless device user/content buyer 422 and wireless devices 424 implemented with metadata simulcast detector application or applet 426. In an embodiment of the invention, digitized A/V content broadcast from satellite 406 is received by content receiver 410, where it is intercepted by metadata simulcaster 414, which decouples and simulcasts metadata associated with the A/V content as it is being played by content delivery system 412. In different embodiments of the invention, decoupled metadata is time stamped and supplemental metadata is appended or substituted including, but not limited to, unique identifiers of the venue where the content is being played, Internet addresses of on-line providers of the A/V content, and special promotions. In an embodiment of the invention, metadata simulcaster 414 comprises a chip-based identification card 416 which provides metadata origination information to facilitate an on-line purchase of associated A/V content. After A/V content metadata is decoupled from the intercepted digitized A/V content stream, processed, and stored for remote and/or later retrieval, it is simulcasted by metadata simulcaster 414 and wireless device users who are potential A/V content buyers 422 are notified that metadata associated with the A/V content currently being played is available, as described in greater detail hereinabove.

Wireless device users/content buyers 422 who decide to receive simulcasted A/V content metadata then boot their wireless devices 424, connect to the venue's wireless access point 418, install a metadata detector application or applet 426, and access simulcasted metadata as described in greater detail hereinabove. In an embodiment of the invention, A/V content metadata displayed on wireless devices 424 includes time-stamped and supplemental metadata including, but not limited to, unique identifiers of the venue 408 where the content is being played, Internet addresses of on-line providers of the A/V content, and special promotions. In this embodiment of the invention, the wireless device user/content buyer 422 can use the displayed A/V content metadata to facilitate the enactment of an on-line purchase of the associated A/V content. In an embodiment of the invention, the wireless device user/content buyer 422 is given the option of using the simulcast metadata to facilitate purchasing a physical copy of the associated A/V content from on-line content merchant 530 and having it delivered to a physical address.

In this embodiment of the invention, the wireless device user/content buyer 422 connects to on-line content merchant 530 and provides shipping and payment details required to purchase of a physical copy of the album containing the associated A/V content. Once the purchase is completed, on-line content merchant 530 ships a physical copy of the associated A/V content 532 to the physical address 534 specified by the wireless device user/content buyer 422. In another embodiment of the invention, the wireless device user/content buyer stores purchase details including, but not limited to, name, shipping and billing addresses, phone numbers, and purchase card information, which can be automatically submitted to on-line content merchant 530 to further facilitate the purchase of associated A/V content. In another embodiment of the invention, if the wireless device user 422 decides not to purchase the associated A/V content at that time, the A/V content metadata is saved to the wireless device 424 facilitating a later purchase of the associated A/V content.

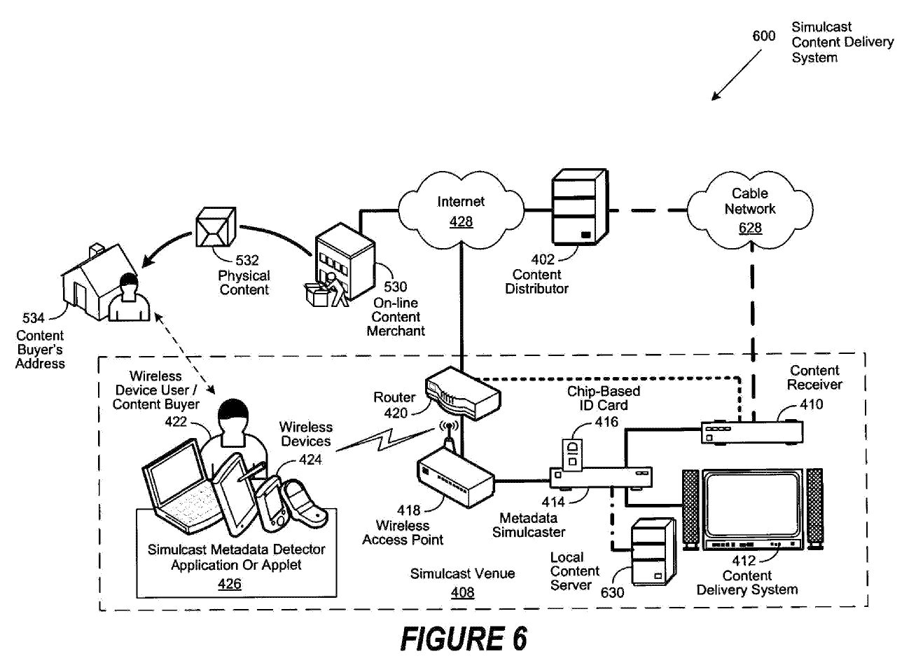

FIG. 6 is a generalized block diagram illustrating an implementation of a metadata simulcaster 414 as used in accordance with an embodiment of the invention for the simulcasting of audio/video (A/V) metadata to a wireless device to facilitate an on-line purchase of an electronic and /or physical copy of the associated content. In this embodiment of the invention, simulcast physical content delivery system 600 comprises content distributor 402, coupled to the Internet 428 and cable network 628, simulcast venue 408, on-line content merchant 530, physical content 532, and content buyer's address 534. Content distributor 402 streams predetermined A/V content with associated metadata through cable network 628 for delivery to simulcast venue 408.

Simulcast venue 408 comprises content receiver 410, A/V content delivery system 412, A/V metadata simulcaster 414, wireless access point 418, router 420, wireless device user/content buyer 422 and wireless devices 424 implemented with metadata simulcast detector application or applet 426. In an embodiment of the invention, digitized A/V content received from content distributor 402 via cable network 628 by content receiver 410 where it is intercepted by metadata simulcaster 414, which decouples and simulcasts metadata associated with the A/V content as it is being played by content delivery system 412. In another embodiment, digitized content is received from content distributor 402 via Internet 428 by content receiver 410 where it is intercepted by metadata simulcaster 414, which decouples and simulcasts metadata associated with the A/V content as it is being played by content delivery system 412. In yet another embodiment, digitized content is not received from content distributor 402 via cable network 628 or Internet 428. Instead, it is received in physical form and stored on local content server 630, where it is conveyed to metadata simulcaster 414, which decouples and simulcasts metadata associated with the A/V content as it is being played by content delivery system 412. In different embodiments of the invention, decoupled metadata is time stamped and supplemental metadata is appended or substituted including, but not limited to, unique identifiers of the venue where the content is being played, Internet addresses of on-line providers of the A/V content, and special promotions. In an embodiment of the invention, metadata simulcaster 414 comprises a chip-based identification card 416 which provides metadata origination information to facilitate an on-line purchase of associated A/V content. After A/V content metadata is decoupled from the intercepted digitized A/V content stream, processed, and stored for remote and/or later retrieval, it is simulcasted by metadata simulcaster 414 and wireless device users who are potential A/V content buyers 422 are notified that metadata associated with the A/V content currently being played is available, as described in greater detail hereinabove.

Wireless device users/content buyers 422 who decide to receive simulcasted A/V content metadata then boot their wireless devices 424, connect to the venue's wireless access point 418, install a metadata detector application or applet 426, and access simulcasted metadata as described in greater detail hereinabove. In an embodiment of the invention, A/V content metadata displayed on wireless devices 424 includes time-stamped and supplemental metadata including, but not limited to, unique identifiers of the venue 408 where the content is being played, Internet addresses of on-line providers of the A/V content, and special promotions. In this embodiment of the invention, the wireless device user/content buyer 422 can use the displayed A/V content metadata to facilitate the enactment of an on-line purchase of the associated A/V content. In an embodiment of the invention, the wireless device user/content buyer 422 is given the option of using the simulcast metadata to facilitate purchasing a physical copy of the associated A/V content from on-line content merchant 530 and having it delivered to a physical address, or purchasing an electronic copy from content distributor 402, or both.

In this embodiment of the invention, the wireless device user/content buyer 422 connects to on-line content merchant 530 and provides shipping and payment details required to purchase of a physical copy of the album containing the associated A/V content. Once the purchase is completed, on-line content merchant 530 ships a physical copy of the associated A/V content 532 to the physical address 534 specified by the wireless device user/content buyer 422. The wireless device user/content buyer 422 then connects to content distributor 402 to conduct and complete the purchase of an electronic copy of the associated A/V content. Once the purchase is completed, the associated A/V content is downloaded through Internet 428, through router 420 and wireless access point 418, and on to wireless devices 424. In another embodiment of the invention, the wireless device user/content buyer stores purchase details including, but not limited to, name, shipping and billing addresses, phone numbers, and purchase card information, which can be automatically submitted to on-line content merchant 530 to further facilitate the purchase of associated A/V content. In another embodiment of the invention, the wireless device user/content buyer 422 downloads the selected A/V content from a content delivery site that they subscribe to, but is not included in the simulcasted A/V content metadata. In another embodiment of the invention, if the wireless device user 422 decides not to purchase the associated A/V content at that time, the A/V content metadata is saved to the wireless device 424 facilitating a later purchase of the associated A/V content. In other embodiments of the invention, wireless device users/content buyers 422 select metadata for a single selection, an entire playlist, or a partial play list, and save the metadata to the wireless device to use as reference for a later purchase of the associated A/V content.

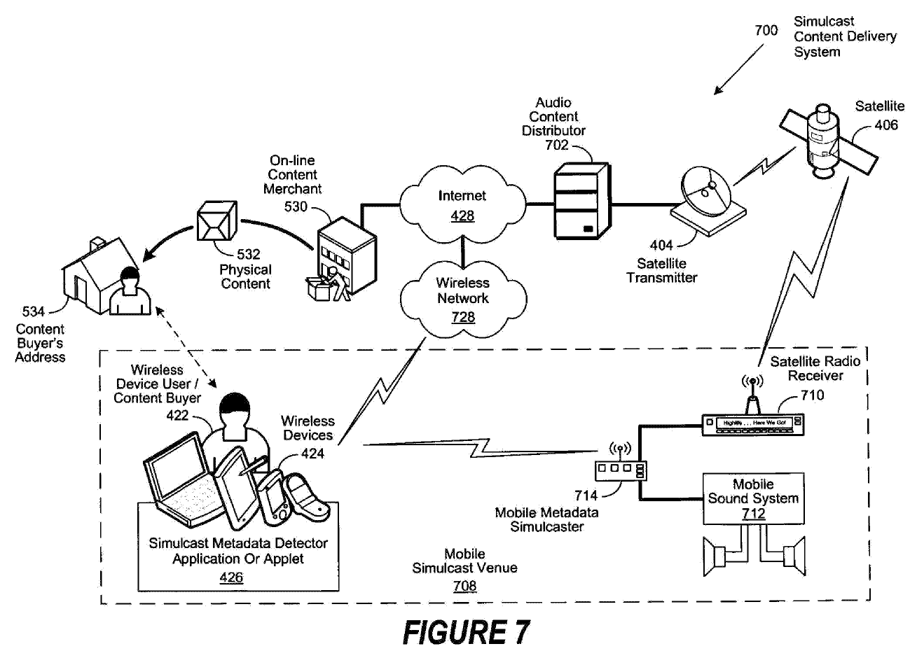

FIG. 7 is a generalized block diagram illustrating an implementation of a mobile metadata simulcaster 714 as used in accordance with an embodiment of the invention for the simulcasting of audio metadata to a wireless device to facilitate an on-line purchase of a electronic or physical copy of the associated content in a mobile environment. In this embodiment of the invention, simulcast digital content delivery system 700 comprises audio content distributor 702, coupled to the Internet 428 and satellite transmitter 404, satellite 406, mobile simulcast venue 708, wireless network 728, on-line content merchant 530, physical content 532, and content buyer's address 534. Wireless network 728 comprises a wireless wide area network (WWAN) implementing communication protocols including, but not limited to, general packet radio (GPRS), Enhanced Data rates for Global Evolution (EDGE), or IEEE 802.16 (WiMAX). Audio content distributor 702 streams predetermined audio content with associated metadata to satellite transmitter 404, which transmits it to satellite 406 for broadcast to mobile simulcast venue 708.

Mobile simulcast venue 708 comprises satellite radio receiver 710, mobile sound system 712, mobile metadata simulcaster 714, wireless device user/content buyer 422, and wireless devices 424 implemented with metadata simulcast detector application or applet 426. In an embodiment of the invention, digitized A/V content broadcast from satellite 406 is received by satellite radio receiver 710 where it is intercepted by mobile metadata simulcaster 714, which decouples and simulcasts metadata associated with the audio content as it is being played by mobile content delivery system 712. In different embodiments of the invention, decoupled metadata is time stamped and supplemental metadata is appended or substituted including, but not limited to, unique identifiers of the venue where the content is being played, Internet addresses of on-line providers of the audio content, and special promotions. After audio content metadata is decoupled from the intercepted digitized audio content stream, it is processed and stored for later retrieval, on mobile metadata simulcaster 714, which then directly simulcasts the resulting metadata using one or more protocols such as, but not limited to, 802.11 (WiFi), global packet radio service (GPRS), short message service (SMS), or Bluetooth.

Wireless device users who are potential audio content buyers 422 are notified as described in greater detail hereinabove that metadata associated with the audio content being played is available through the use of wireless-enabled devices 424 including, but not limited to laptop computers, personal digital assistants (PDAs), portable media players and cell phones. Wireless device users/content buyers 422 who decide to receive simulcasted audio content metadata boot their wireless devices 424 to directly connect to mobile decoder/simulcaster 714 at which point the wireless device user/content buyer 422 is prompted to install a metadata detector application or applet 426. In one embodiment of the invention, the metadata detector application or applet 426 is downloaded through wireless network 728, which in turn is connected to the Internet 726. In one embodiment of the invention, the audio metadata detector application or applet 426 automatically detects and displays audio content metadata that is simulcasted, or “pushed”, by mobile metadata simulcaster 714. In another embodiment of the invention, the metadata detector application or applet 426 displays an advisory screen or link to “pull” the wireless device user/content buyer 422 to the mobile metadata simulcaster 714, which acts as a server for providing simulcasted and/or stored audio content metadata. Once a metadata detector application or applet 426 is installed on a wireless device 424, audio content metadata, including information facilitating an on-line purchase of the associated audio content, is displayed on the wireless device 424 as described in greater detail hereinabove.

In an embodiment of the invention, audio content metadata displayed on wireless devices 424 includes time-stamped and supplemental metadata including, but not limited to, unique identifiers of the mobile venue 708, such as how the content is being played (e.g., the unique electronic identifier of the satellite radio receiver), Internet addresses of on-line providers of the audio content, and special promotions. In this embodiment of the invention, the wireless device user/content buyer 422 can use the displayed audio content metadata to facilitate the enactment of an on-line purchase of the associated audio content. In an embodiment of the invention, the wireless device user/content buyer 422 is given the option of using the simulcast metadata to facilitate purchasing a physical copy of the associated audio content from on-line content merchant 530 and having it delivered to a physical address, or purchasing an electronic copy from audio content distributor 702, or both.

In this embodiment of the invention, the wireless device user/content buyer 422 connects to on-line content merchant 530 via wireless network 728, described in greater detail hereinabove, which in turn is coupled to the Internet 428, and provides shipping and payment details required to purchase of a physical copy of the album containing the associated audio content. Once the purchase is completed, on-line content merchant 530 ships a physical copy of the associated audio content 532 to the physical address 534 specified by the wireless device user/content buyer 422. The wireless device user/content buyer 422 then connects to audio content distributor 702 to conduct and complete the purchase of an electronic copy of the associated audio content. Once the purchase is completed, the associated audio content is downloaded through Internet 428, through wireless network 728, and on to wireless device 424. Skilled practitioners in the art will recognize that many other embodiments and variations of the present invention are possible. In addition, each of the referenced components in this embodiment of the invention may be comprised of a plurality of components, each interacting with the other in a distributed environment. Furthermore, other embodiments of the invention may expand on the referenced embodiment to extend the scale and reach of the system's implementation.

What is claimed is:

1. A system for controlling the delivery of digital information, comprising:
a content receiver operable to receive a digital content stream and to generate a decoded digital content data stream therefrom; and
a metadata simulcaster operable to:
receive said decoded digital content data stream and extract metadata therefrom;
process said metadata to add supplemental data thereto, thereby generating supplemented metadata; and
wirelessly retransmit said supplemented metadata.

2. The system of claim 1, wherein said supplemented metadata is received by a wireless device.

3. The system of claim 2, wherein said supplemented metadata is stored on said simulcaster for access at a later time.

4. The system of claim 2, wherein said supplemented metadata is retransmitted by said simulcaster immediately.

5. The system of claim 2, wherein said wireless device comprises a metadata detector operable to receive said retransmitted supplemented metadata.

6. The system of claim 2, wherein said simulcaster is operable to push said retransmitted supplemented metadata and said digital content to said wireless device.

7. The system of claim 2, wherein said simulcaster is operable to pull said wireless device to said retransmitted supplemented metadata.

8. The system of claim 2, wherein said retransmitted supplemented metadata comprises a metadata tag.

9. The system of claim 8, wherein said metadata tag comprises content purchase information.

10. The system of claim 1, wherein said retransmitted supplemented metadata and said digital content are simulcasted in conjunction with a satellite radio receiver.

11. A method for controlling the delivery of digital information, comprising:
using a content receiver to receive a digital content stream and to generate a decoded digital content data stream therefrom; and
using a metadata simulcaster to:
receive said decoded digital content data stream and extract metadata therefrom;
process said metadata to add supplemental data thereto, thereby generating supplemented metadata; and
wirelessly retransmit said supplemented metadata.

12. The method of claim 11, further comprising:
receiving said supplemented metadata with a wireless device.

13. The method of claim 12, further comprising:
storing said supplemented metadata on said simulcaster for access at a later time.

14. The method of claim 12, wherein said supplemented metadata is retransmitted by said simulcaster immediately.

15. The method of claim 12, wherein said wireless device comprises a metadata detector operable to receive said retransmitted supplemented metadata.

16. The method of claim 12, further comprising:
using said simulcaster to push said retransmitted supplemented metadata and said digital content to said wireless device.

17. The method of claim 12, further comprising:
using said simulcaster to pull said wireless device to said retransmitted supplemented metadata.

18. The method of claim 12, wherein said retransmitted supplemented metadata comprises a metadata tag.

19. The method of claim 18, wherein said metadata tag comprises content purchase information.

20. The method of claim 11, further comprising:
simulcasting said supplemented metadata and said digital content in conjunction with a satellite radio receiver.
